(19) United States
(12) Patent Application Publication
(10) Pub. No.: US 2007/0026291 A1
(43) Pub. Date: Feb. 1, 2007

(54) Membrane-electrode assembly for fuel cell and fuel cell system comprising the same

(76) Inventors: Hee-Tak Kim, Suwon-si (KR); Ho-Jin Kweon, Suwon-si (KR)

Correspondence Address: Robert E. Bushnell;Suite 300, 1522 K Street, N.W., Washington, DC, 20005, US

(21) Appl. No.: 11/493,578

(22) Filed: Jul. 27, 2006

(30) Foreign Application Priority Data
Jul. 27, 2005 (KR) 10-2005-0068599

(51) Int. Cl. H01M 4/86; H01M 8/10; H01M 4/88; B05D 5/12

(52) U.S. Cl. 429/40; 429/30; 429/44; 502/101; 427/115

(57) ABSTRACT

The present invention relates to a membrane-electrode assembly and a fuel cell system including the membrane-electrode assembly. The membrane-electrode assembly includes a corrugated polymer electrolyte membrane and an anode and a cathode respectively disposed at each side of the polymer electrolyte membrane. The corrugated polymer electrolyte membrane has a pattern on its surface, and the corrugated surface of the polymer electrolyte membrane increase an area of an interface between the polymer electrolyte membrane and a catalyst layer. The present invention provides a fuel cell system with high power and high performance by adapting the corrugated polymer electrolyte membrane to a membrane-electrode assembly of a fuel cell.

### CLAIM OF PRIORITY

This application makes reference to, incorporates the same herein, and claims all benefits accruing under 35 U.S.C. § 119 from an application for MEMBRANE-ELECTRODE ASSEMBLY FOR FUEL CELL AND FUEL CELL SYSTEM COMPRISING SAME, earlier filed in the Korean Intellectual Property Office on the 27^{th} of Jul., 2005 and there duly assigned Serial No. 10-2005-0068599.

### BACKGROUND OF THE INVENTION

1. Field of the Invention

The present invention relates to a membrane-electrode assembly for a fuel cell and a fuel cell system including the same. More particularly, the present invention relates to a membrane-electrode assembly for a fuel cell with a high performance and a fuel cell system including the same.

2. Description of the Related Art

A fuel cell is a power generation system for producing electrical energy through an electrochemical redox reaction of an oxidant and a fuel such as hydrogen or a hydrocarbon-based material that includes methanol, ethanol, natural gas, or the like. Such a fuel cell is a clean energy source that can replace fossil fuels. It includes a stack composed of unit cells and produces various ranges of power output. Since it has four to ten times higher energy density than a small lithium battery, it has been highlighted as a small portable power source. Representative exemplary fuel cells include a polymer electrolyte membrane fuel cell (PEMFC) and a direct oxidation fuel cell (DOFC). The direct oxidation fuel cell includes a direct methanol fuel cell which uses methanol as a fuel.

The polymer electrolyte fuel cell has advantages of high energy density and high power output, but also has problems which include the need to carefully handle hydrogen gas and the requirement of accessory facilities such as a fuel reforming processor for reforming methane or methanol, natural gas, or the like in order to produce hydrogen to be used as a fuel gas.

On the contrary, a direct oxidation fuel cell has a lower energy density than that of the gas-type fuel cell, but has advantages that include easy handling of liquid-type fuel, a low operating temperature, and no need for additional fuel reforming processors. Therefore, it has been acknowledged that the direct oxidation fuel cell is an appropriate system for a portable power source for small electrical equipment.

In the above mentioned fuel cell systems, a stack, which generates electricity, substantially includes several to scores of unit cells that are stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated from the anode by a polymer electrolyte membrane.

A fuel is supplied to the anode, adsorbed by catalysts of the anode, and then oxidized to produce protons and electrons. The electrons are transferred to the cathode via an out-circuit, and the protons are also transferred to the cathode through the polymer electrolyte membrane. In addition, an oxidant is supplied to the cathode, and then the oxidant, protons, and electrons are reacted in catalysts of the cathode to produce electricity along with water.

The above description disclosed in this background section is only to improve understanding of the present invention, and therefore it should be noted that the above description may contain information that is not known to one skilled in the art, and the above description should not be considered as admitted prior art.

### SUMMARY OF THE INVENTION

An embodiment of the present invention provides a membrane-electrode assembly for a fuel cell that provides a high performance fuel cell by increasing an interface area between a polymer electrolyte membrane and an electrode. Another embodiment of the present invention provides a fuel cell system that includes the above mentioned membrane-electrode assembly and shows high performance in generating electricity.

According to an embodiment of the present invention, a membrane-electrode assembly for a fuel cell is provided, which includes a polymer electrolyte membrane having corrugated portions, a first electrode substrate, and a second electrode substrate. The first and the second electrode substrates are disposed at each side of the polymer electrolyte membrane, respectively. The first electrode substrate may have a corrugated pattern, and may be substantially the same as the corrugated pattern of the polymer electrolyte membrane.

According to another embodiment of the present invention, a fuel cell system is provided, which includes an electricity generating element including the above mentioned membrane-electrode assembly, separators, a fuel supplier, and an oxidant supplier. The electricity generating element generates electricity through processes of oxidation of a fuel and reduction of an oxidant. The fuel supplier supplies a fuel, which includes hydrogen, to the electricity generating element, and the oxidant supplier supplies an oxidant to the electricity generating element.

The present invention also provides a method of making a membrane-electrode assembly. The method includes steps of disposing a first electrode on a first patterned mold, disposing a polymer electrolyte membrane on the first electrode, and forming the pattern of the first patterned mold on a first surface of the polymer electrolyte membrane. The method further includes steps of disposing a second electrode on the polymer electrolyte membrane, disposing a second patterned mold on the second electrode, and forming the pattern of the second patterned mold on a second surface of the polymer electrolyte membrane. The step of forming the pattern of the first patterned mold on a first surface of the polymer electrolyte membrane may include a step of pressing the polymer electrolyte membrane to the first patterned mold, and heat may be applied during the step of pressing the polymer electrolyte membrane to the first patterned mold.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a membrane-electrode assembly that includes a polymer electrolyte membrane with corrugated portions;

FIG. 2 shows an interface between a flat polymer electrolyte membrane and a catalyst layer of a fuel cell;

FIG. 3 shows processes for fabricating a polymer electrolyte membrane according to one embodiment of the present invention;

FIG. 4 shows processes for fabricating a polymer electrolyte membrane according to another embodiment of the present invention;

FIG. 5 shows processes for fabricating a polymer electrolyte membrane according to another embodiment of the present invention;

FIG. 6 shows a structure of a fuel cell system constructed according to the principles of the present invention;

FIG. 7 shows a plane scanning electron microscope (SEM) photograph of a polymer electrolyte membrane of Example 1 of the present invention;

FIG. 8 shows a cross-sectional SEM photograph of a polymer electrolyte membrane of Example 1 of the present invention;

FIG. 9 shows a plane SEM photograph of a polymer electrolyte membrane of Example 2 of the present invention;

FIG. 10 shows a cross-sectional SEM photograph of a polymer electrolyte membrane of Example 2 of the present invention;

FIG. 11 shows a cross-sectional SEM photograph of a polymer electrolyte membrane of Example 3 of the present invention; and

FIG. 12 shows voltage-current characteristics and power density characteristics of fuel cell systems described in Examples 5 to 6 of the present invention and a fuel system described in Comparative Example 1.

### DETAILED DESCRIPTION OF THE INVENTION

The present invention relates to a membrane-electrode assembly for a fuel cell and, more particularly, to a membrane-electrode assembly that improves performance of a fuel cell.

In general, a membrane-electrode assembly for a fuel cell includes a polymer electrolyte membrane, and an anode and a cathode which are respectively positioned at each side of the polymer electrolyte membrane. The membrane-electrode assembly generates electricity through processes of oxidation of a fuel and reduction of an oxidant. High interface adherence between a polymer electrolyte membrane and an electrode, as well as a large contact area therebetween, improves the activity of the oxidation and reduction processes, and makes the fuel cell generate more electricity.

According to an embodiment of the present invention, the polymer electrolyte membrane of the membrane-electrode assembly has a corrugated portion. The corrugated portion may increase the contact area between the polymer electrolyte membrane and an electrode catalyst layer that is formed on the surface of the electrode, and thereby, may improve the interface adherence therebetween. It also increases the amount of catalyst contacting the polymer electrolyte membrane, and thereby increases its usage rate, which provides high performance for the fuel cell. Herein, the corrugated portion is also referred to corrugated pattern or corrugated structure in the description of the present invention.

In the corrugated portion of the polymer electrolyte membrane, the ratio of a real area (actual area) to an apparent area (or geometric area) is between 1.3 and 200, and preferably between 2 and 20. The real area is defined as an area of the entire surface of the corrugated portion including concave and convex parts, while the apparent area is obtained, for example, by multiplying a width and a length of the outline of the surface of the polymer electrolyte membrane. Herein, a ratio of a real area (actual area) to an apparent area (or geometric area) is defined as an area ratio. When the area ratio (the ratio of the real area to the apparent area) is less than 1.3, the effect of increasing the interface area is little, while when the ratio is more than 200, it is technically difficult to make the corrugated portion.

The height (or depth) of the corrugated portion, which is defined as a length between peaks of concave and convex parts, is 1 μm to 50 μm, and preferably 2 μm to 20 μm. Herein, a height of a corrugated portion is also referred to a height of a corrugated structure or pattern as defined above. When the depth is less than 1 μm, even though the interface area between the polymer electrolyte membrane and the catalyst layer increases, the effect of increasing volume of catalyst, which is required to deliver a large number of proton ions through the interface between the catalyst layer and the polymer electrolyte membrane, is little, and therefore the improvement of performance of the fuel cell is not great. When the depth is greater than 50 μm, it is difficult to uniformly maintain the corrugated portion during the compression process for preparing a membrane-electrode assembly.

According to the embodiment of the present invention, the corrugated portion may be formed on only one side or both sides of the polymer electrolyte membrane. However, when the corrugated portion is formed on both sides of the polymer electrolyte membrane, the overall contact between the electrode catalyst and the polymer electrolyte membrane increases, and therefore power output of the fuel cell is improved.

The corrugated portion may be regularly formed. If the corrugated portion is irregularly 8 formed, the effect of increasing the interface area may be locally different, and may not be uniform. Therefore, current produced through the polymer electrolyte membrane is uneven, which would provide poor performance for the fuel cell. Herein, regular corrugated portion means that the pattern has substantially identical corrugated local structure. The regular corrugated structure may include a periodic sine-wave shape structure, structure with periodic projections, or egg-tray shape structure, but the shape of the regular corrugated structure is not limited to the structure listed above.

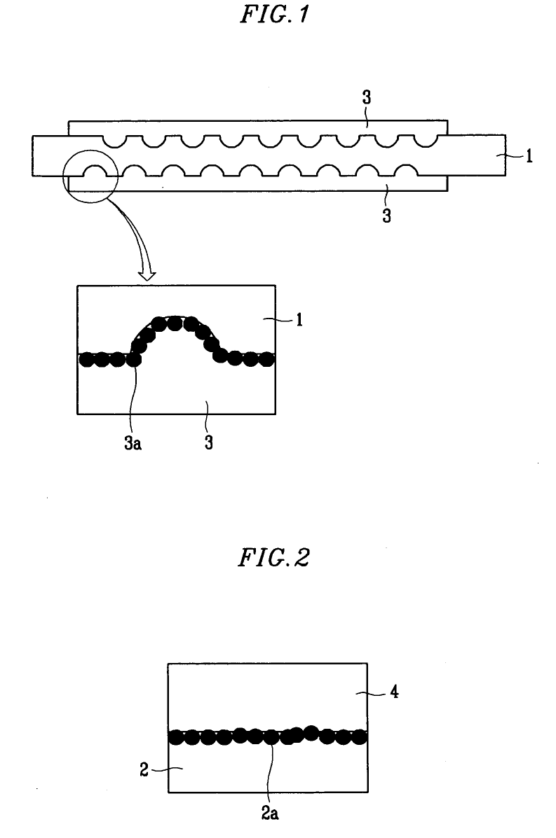

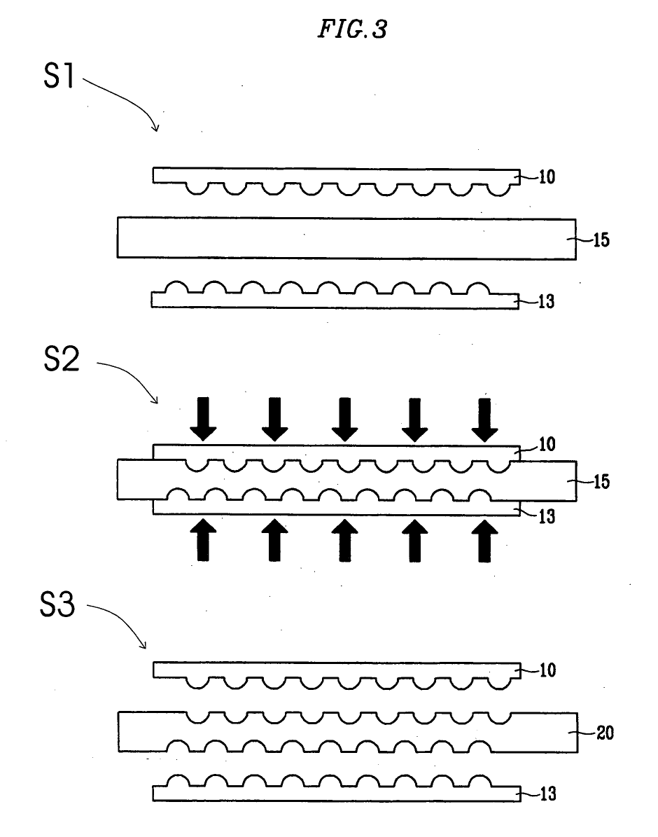

FIG. 1 shows a schematic view of a membrane-electrode assembly including catalyst layer 3 disposed at both sides of corrugated polymer electrolyte membrane 1. Corrugated portion is enlarged to show interface 3a between polymer electrolyte membrane 1 and catalyst layers 3. FIG. 2 shows interface 2a between flat polymer electrolyte membrane 2 and catalyst layer 4 when there is no corrugated portion. Interface 3a between polymer electrolyte membrane 1 and catalyst layers 3 as shown in FIG. 1 is remarkably larger than interface 2a between flat polymer electrolyte membrane 2 and catalyst layer 4 shown in FIG. 2. That is to say, the area of the interface of corrugated polymer electrolyte membrane is larger than that of the interface of the flat polymer electrolyte membrane.

FIG. 3 shows one embodiment of preparing a corrugated polymer electrolyte membrane according to the principles of the present invention. In the first step S1, patterned substrates (or molds) 10 and 13 are respectively disposed at each side of a flat polymer electrolyte membrane 15. In the next step S2, flat polymer electrolyte membrane 15 is compressively rolled by patterned substrates 10 and 13. Then, in the step S3, corrugated polymer electrolyte membrane 20, where each side of the polymer electrolyte membrane is corrugated, is produced. The compressive rolling may include a hot rolling, which is performed under heat and pressure, or a cold rolling that is performed without heat.

Patterned substrate 10 or 13 may be made of a metal material having no thermal deformation such as stainless steel, nickel, titanium, aluminum, copper, or so on. Patterned substrate 10 or 13 may be also made of a polymer material having low thermal deformation and excellent mechanical strength, for example, a fiber reinforced plastic, such as polyimide or polytetrafluoro ethylene (TEFLON), or so on.

The hot rolling process is performed with a pressure of 10 kgf/cm² to 1000 kgf/cm², and preferably, 50 kgf/cm² to 500 kgf/cm². When the pressure is less than 10 kgf/cm², a polymer electrolyte membrane may not have a clear pattern. When it is more than 1000 kgf/cm², the polymer 8 electrolyte membrane may have pinholes.

The hot rolling may be performed in a range of 50° C. above and below the thermal deformation temperature of the polymer electrolyte membrane. In other words, if the thermal deformation temperature of the polymer electrolyte membrane is T, the temperature of hot rolling would be between T−50° C. and T+50° C. For example, perflurosulfonic acid (NAFION) may be hot-rolled in a range of 60° C. to 160° C., and preferably 135° C. to 160° C. The cold rolling may be performed with a pressure of 10 kgf/cm² to 1000 kgf/cm², and preferably 50 kgf/cm² to 500 kgf/cm².

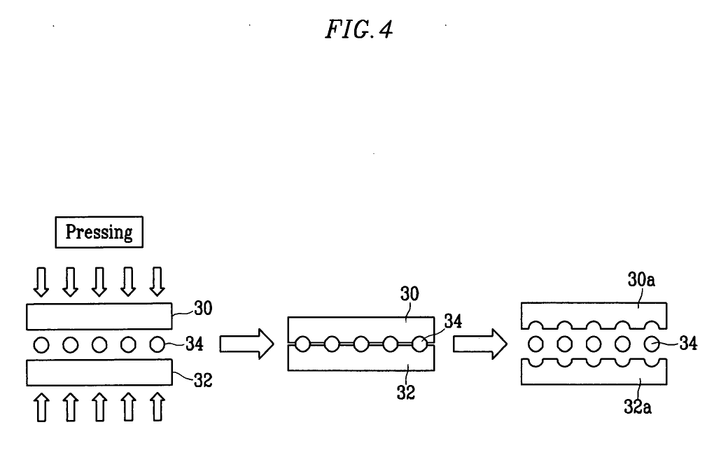

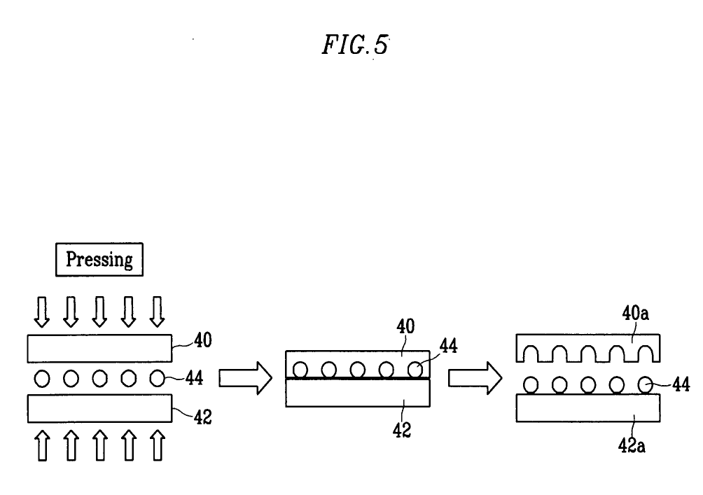

FIG. 4 shows another embodiment of preparing a polymer electrolyte membrane according to the principles of the present invention. Polymer electrolyte membranes 30 and 32 are positioned at each side of micro-patterned substrate 34, respectively, and then compressively rolled with micro-patterned substrate 34. After the rolling process, polymer electrolyte membranes 30a and 32a, one side of which is corrugated, are produced.

Furthermore, as shown in FIG. 5, polymer electrolyte membrane 40 may be positioned at one side of substrate 44, and hard substrate 42 is positioned at the other side of substrate 44. Then, they are compressively rolled to produce a corrugated polymer electrolyte membrane 40a.

The micro-patterned substrate may include a mesh, a corrugated metal plate, a metal roll, or a metal ball. The mesh may be made of any heat and pressure resistant material, such as stainless steel, which is able to make a corrugated structure on a polymer electrolyte membrane. When metal ball is used for the micro-patterned substrate, the metal balls are first spread on the surface of a polymer electrolyte membrane, and compressively rolled together with the polymer electrolyte membrane to make a corrugated structure on the polymer electrolyte membrane. After the rolling process, metal balls are removed from the surface of the polymer electrolyte membrane. As another method of making a corrugated polymer electrolyte membrane, a membrane material may be injected into a patterned mold. Then, a corrugated polymer electrolyte membrane can be easily made after a predetermined process of molding.

A polymer electrolyte membrane functions as an ion exchange medium that transfers protons generated in an anode catalyst to a cathode catalyst, and thus may include a high proton-conductive polymer. The proton conductive polymer may be a polymer resin having at its side chain a cation exchange group selected from the group consisting of a sulfonic acid group, a carboxylic acid group, a phosphoric acid group, a phosphonic acid group, and derivatives thereof. The polymer electrolyte membrane may include at least one selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In a preferred embodiment, the polymer electrolyte membrane includes proton conductive polymers selected from the group consisting of poly(perfluorosulfonic acid) (NAFION™), poly(perfluorocarboxylic acid), a copolymer of tetrafluoroethylene and fluorovinyletherhaving a sulfonic acid group, defluorinated polyetherketone sulfide, aryl ketone, poly(2,2′-(m-phenylene)-5,5′-bibenzimidazole), and poly(2,5-benzimidazole). In general, the polymer membrane has a thickness ranging from 10 μm to 200 μm.

According to the embodiment of the present invention, an anode and a cathode of a membrane-electrode assembly include an electrode substrate and a catalyst layer disposed thereon.

The catalyst layer may include at least one selected from the group consisting of platinum, ruthenium, osmium, platinum-ruthenium alloys, platinum-osmium alloys, platinum-palladium alloys, platinum-M alloys, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), and combinations thereof. The same material may be used for both an anode and a cathode. However, in the case of a direct oxidation fuel cell, an anode catalyst may be poisoned by carbon monoxide (CO), and therefore CO-tolerant platinum-ruthenium alloy catalysts may be more suitable for an anode catalyst.

The metal catalyst may be used in a form of a metal itself (a black catalyst), or in a form of being supported in a carrier. The carrier may include carbon such as acetylene black, denka black, activated carbon, ketjen black, and graphite, or may include inorganic material particulate such as alumina, silica, titania, zirconia, and so on. In general, carbon is used for the carrier.

The electrode substrate plays a role of supporting an electrode, and also of spreading a fuel and an oxidant to a catalyst layer in order to make the fuel and the oxidant easily approach the catalyst layer. As for the electrode substrate, a conductive substrate is used, for example, carbon paper, carbon cloth, carbon felt, or metal cloth. Metal cloth is a porous film comprised of a metal cloth fiber, or a metallized polymer fiber. The material of the conductive substrate, however, is not limited to these materials listed above.

The electrode substrate may have a corrugated structure on a surface that faces a polymer electrolyte membrane. The corrugated structure of the electrode substrate may be formed during an assembly process of the electrode substrate with a corrugated polymer electrolyte membrane, or may be formed separately before being assembled with a corrugated polymer electrolyte membrane.

During an assembly process of a fuel cell, electrode substrates are disposed at both sides of a polymer electrolyte membrane, and pressed together with the polymer electrolyte membrane to make a unit membrane-electrode assembly. Under the pressure applied to the electrode substrates, a corrugated pattern would be formed on the surfaces of the electrode substrates, because of the corrugated pattern formed on the polymer electrolyte membrane. In this case, the shape of the corrugated pattern formed on the electrode substrate would be substantially the same as the corrugated pattern formed on the polymer electrolyte membrane, and the concave and convex parts of the corrugated patterns of the polymer electrolyte membrane and the electrode substrates would be well matched to each other. A catalyst layer or other layers may be disposed between an electrode substrate and a polymer electrolyte membrane, but the same principle described above is applied to make the corrugated electrode substrate.

Meanwhile, if the corrugated pattern is separately formed on a surface of an electrode substrate, the corrugated pattern may be the same as the pattern formed on a polymer electrolyte membrane, or may be different from the pattern formed on a polymer electrolyte membrane. Therefore, the corrugated pattern of the electrode substrate may be matched with the pattern of the polymer electrolyte membrane, or may not be matched with the pattern of the polymer electrolyte membrane. In either case, the corrugated electrode substrate provides an effect of increasing an area of an interface between an electrode substrate and a polymer electrolyte membrane.

A micro-porous layer (MPL) can be added between the electrode substrate and the catalyst layer to increase effect of reactant diffusion. In general, the micro-porous layer may include, but is not limited to, a small-sized conductive powder such as a carbon powder, carbon black, acetylene black, activated carbon, a carbon fiber, fullerene, a nano-carbon, or combinations thereof. The nano-carbon may include a material such as carbon nanotubes, carbon nanofiber, carbon nanowire, carbon nanohorns, carbon nanorings, or combinations thereof. The micro-porous layer is formed by coating the electrode substrate with a composition including a conductive powder, a binder resin, and a solvent.

The binder resin may include, but is not limited to, polytetrafluoro ethylene (PTFE), polyvinylidene fluoride, polyhexafluoro propylene, polyperfluoroalkylvinyl ether, polyperfluoro sulfonyl fluoride, alkoxy vinyl ether, polyvinylalcohol, celluloseacetate, or copolymers thereof. The solvent may include, but is not limited to, an alcohol, water, dimethylacetamide (DMAc), dimethyl formamide, dimethyl sulfoxide (DMSO), N-methylpyrrolidone, or tetrahydrofuran. An example of the alcohol is ethanol, isopropyl alcohol, ethyl alcohol, n-propyl alcohol, or butyl alcohol.

The coating method may include, but is not limited to, screen printing method, spray coating method, doctor blade methods, and so on, depending on the viscosity of the composition.

A fuel cell system including the membrane-electrode assembly of the present invention includes at least one electricity generating element, a fuel supplier, and an oxidant supplier. The electricity generating element includes a membrane-electrode assembly that includes a polymer electrolyte membrane, a cathode, and an anode. The cathode is positioned at one side of the polymer electrolyte membrane, and the anode at the other side of the polymer electrolyte membrane. The electricity generating element generates electricity through processes of oxidation of a fuel and reduction of an oxidant. The fuel includes liquid hydrogen, hydrogen gas, or a hydrocarbon-based fuel such as methanol, ethanol, propanol, butanol, or natural gas.

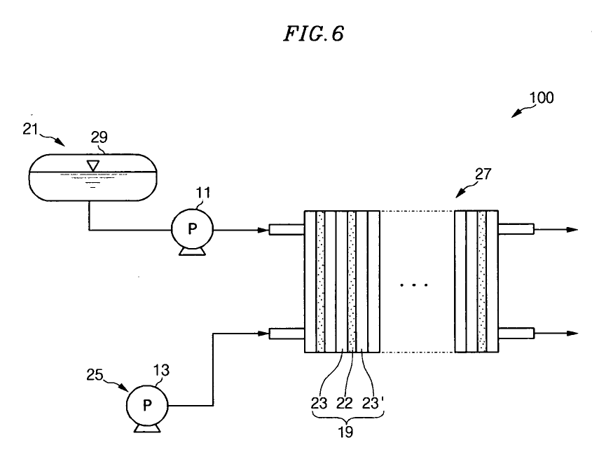

FIG. 6 shows a schematic structure of a fuel cell system that will be described in detail with references to this accompanying drawing. FIG. 6 illustrates a fuel cell system, where a fuel and an oxidant are provided to the electricity generating element through pumps, but the present invention is not limited to these structures. The fuel cell system of the present invention alternatively may include a structure, where a fuel and an oxidant are provided through a diffusion process such as a diffusion process caused by osmotic pressure.

A fuel cell system 100 includes at least one electricity generating element 19 that generates electrical energy through an electrochemical reaction of a fuel and an oxidant, fuel supplier 21 for supplying a fuel to the electricity generating element 19, and oxidant supplier 25 for supplying an oxidant to electricity generating element 19. One or multiple electricity generating elements 19 constitutes stack 27.

In addition, fuel supplier 21 is equipped with tank 29 that stores the fuel, and pump 11 that is connected to tank 29. Fuel pump 11 supplies the fuel stored in tank 29 with a predetermined pumping power. Oxidant supplier 25, which supplies an oxidant to electricity generating element 19 of stack 27, is equipped with at least one pump 13 for supplying an oxidant to stack 27 with a predetermined pumping power. Electricity generating element 19 includes membrane-electrode assembly 22 that oxidizes hydrogen or a fuel and reduces an oxidant, and separators 23 and 23′ that are respectively positioned at each side of membrane-electrode assembly 22, and supply hydrogen or a fuel, and an oxidant.

The following examples illustrate the present invention in more detail. However, it is understood that the present invention is not limited by these examples.

### EXAMPLE 1

A NAFION 115 (perfluorosulfonic acid) membrane, which is commercially available, was disposed at one side of a stainless steel mesh that was formed by using a metal fiber with a diameter of 30 μm and with a distance of 87 μm between the fibers. Then, the stainless steel mesh with the NAFION 115 (perfluorosulfonic acid) membrane was heated at 135° C. and pressed at 300 kgf/cm² to produce a polymer electrolyte membrane, one side of which was regularly corrugated.

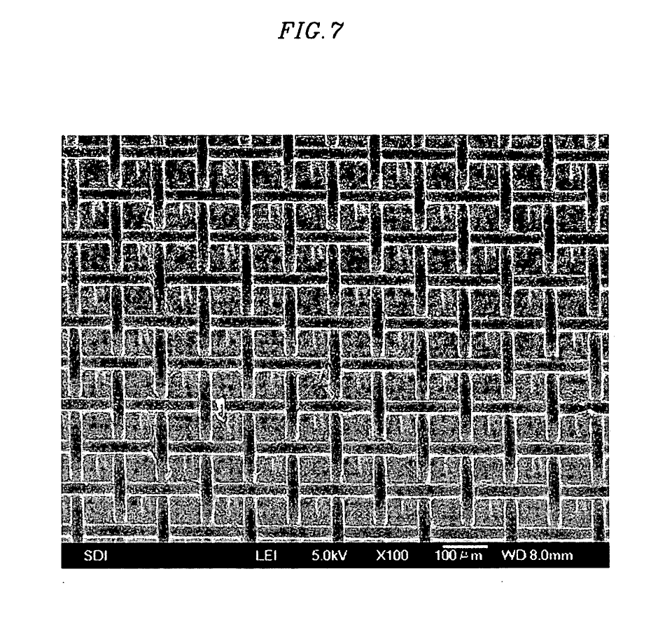

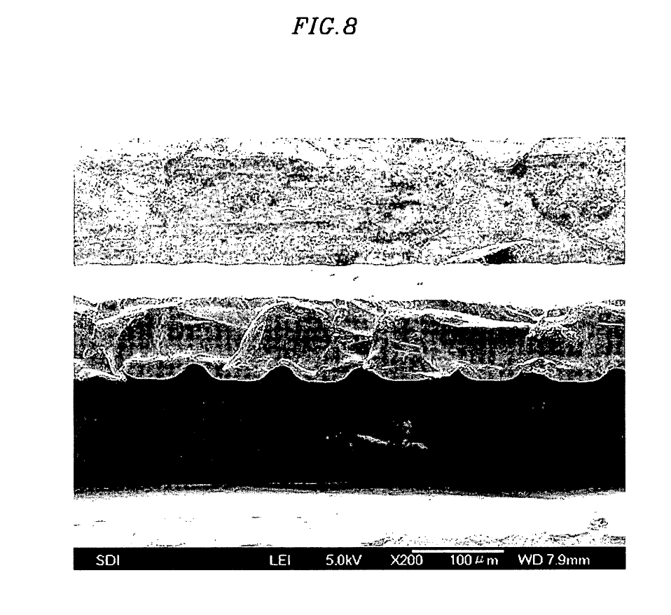

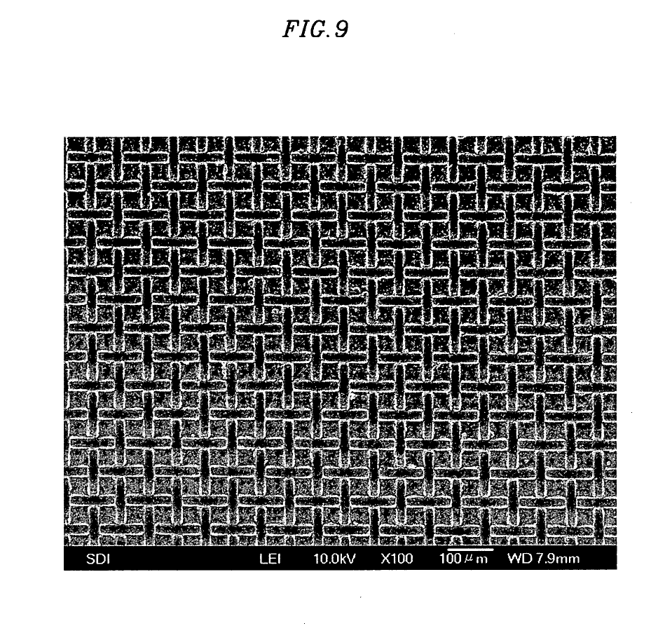

The polymer electrolyte membrane, which was produced this method, has an area ratio of 2.1, which is a ratio of the real area to the apparent area, and a height of 20 μm, which is a height between peaks of concave part and convex part in the corrugated structure. FIGS. 7 and 8 respectively show plane and cross-sectional scanning electron microscope (SEM) photographs of the prepared polymer electrolyte membrane.

### EXAMPLE 2

A NAFION 115 (perfluorosulfonic acid) membrane, which is commercially available, was disposed at one side of a stainless steel mesh as a patterned substrate that was formed by using a metal fiber with a diameter of 11.5 μm and with a distance of 52.5 μm between the fibers. Then, the stainless steel mesh with the NAFION 115 (perfluorosulfonic acid) membrane was heated at 135° C. and pressed at 300 kgf/cm² to produce a polymer electrolyte membrane, one side of which was regularly corrugated.

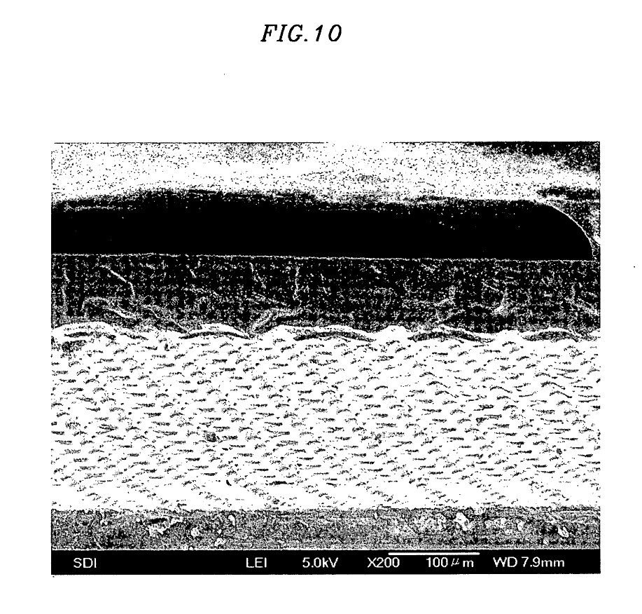

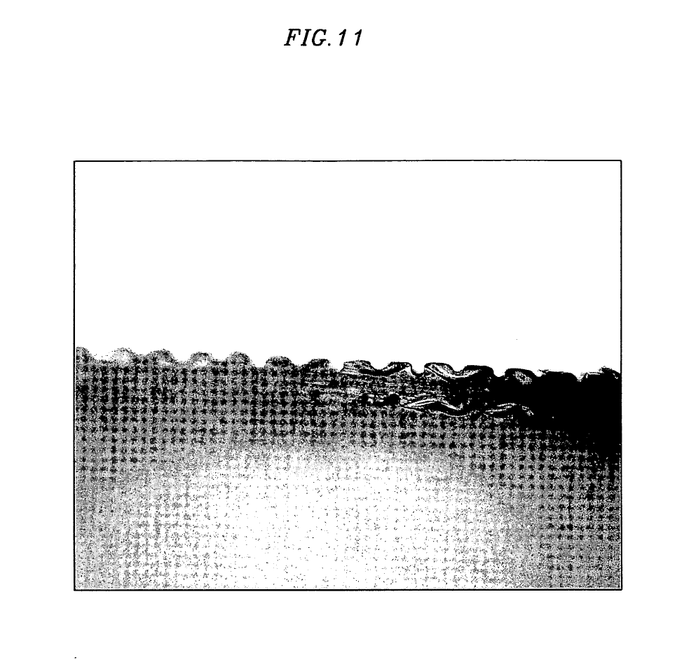

The prepared polymer electrolyte membrane has an area ratio of 2.4, which is a ratio of the real area to the apparent area, and a height of 10 μm, which is a height between peaks of concave part and convex part in the corrugated structure. FIGS. 9 and 10 respectively show plane and cross-sectional SEM photographs of the prepared polymer electrolyte membrane.

### EXAMPLE 3

A NAFION 115 (perfluorosulfonic acid) membrane, which is commercially available, was disposed between two sheets of a stainless steel mesh as patterned substrates. The stainless steel mesh was formed by using a metal fiber with a diameter of 30 μm and with a distance of 87 μm between the fibers. Then, the stainless steel mesh with the NAFION 115 (perfluorosulfonic acid) membrane was heated at 135° C. and pressed at 300 kgf/cm² to produce a polymer electrolyte membrane, both sides of which were regularly corrugated. FIG. 11 shows a cross-sectional photograph of the prepared polymer electrolyte membrane.

### EXAMPLE 4

A NAFION 115 (perfluorosulfonic acid) membrane, which is commercially available, was disposed between two sheets of a stainless steel mesh as patterned substrates. The stainless steel mesh was formed by using a metal fiber with a diameter of 11.5 μm and with a distance of 52.5 μm between the fibers. The stainless steel mesh with the NAFION 115 (perfluorosulfonic acid) membrane was heated at 135° C. and pressed at 300 kgf/cm²/cm² to make a polymer electrolyte membrane, both sides of which were regularly corrugated.

### EXAMPLE 5

A mixture of Pt black, NAFION (perfluorosulfonic acid), and isopropyl alcohol in a weight ratio of 1:0.12:9 was sprayed on one side of a polymer electrolyte membrane made in Example 3, and thereafter, as the isopropyl alcohol evaporated, a cathode catalyst layer was formed.

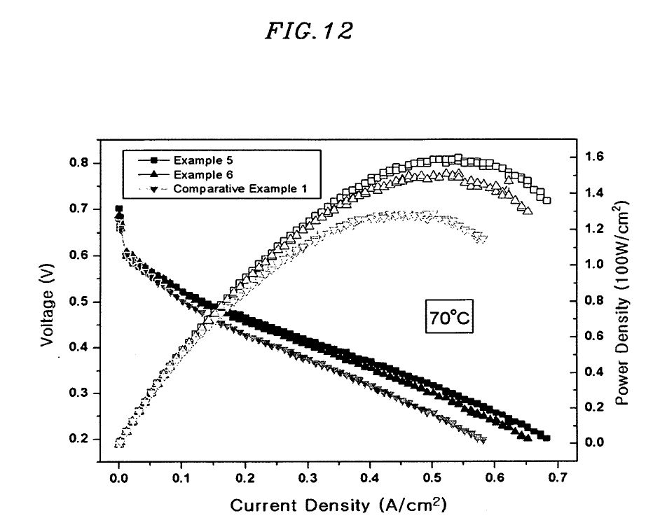

A mixture of Pt—Ru black, NAFION, and isopropyl alcohol in a weight ratio of 1:0.12:9 was sprayed to coat the other side of the polymer electrolyte membrane, and thereafter, the isopropyl alcohol was evaporated to form an anode catalyst layer. Then, a carbon paper electrode substrate was physically pressed at both sides of the polymer electrolyte membrane coated with the catalyst layers to make a unit membrane-electrode assembly. The unit membrane-electrode assembly was examined by measuring voltage-current characteristics at 70° C. by using 1 M of a methanol solution as an anode fuel and injecting air into a cathode. Power density characteristics were obtained from the voltage-current measurement. FIG. 12 shows the results. The results of Example 5 are drawn with open and filled squares in FIG. 12. Open squares refer to power density data shown in right y-axis of the graph, and filled squares refer to voltage data shown in left y-axis of the graph.

### EXAMPLE 6

A unit membrane-electrode assembly was prepared in the same method as described in Example 5 except for using a polymer electrolyte membrane made in Example 4. Then, the membrane-electrode assembly was examined by measuring voltage-current characteristics. Power density characteristics were obtained from the voltage-current measurement. The results are provided in FIG. 12. The results of Example 6 are drawn with open and filled triangles in FIG. 12.

### COMPARATIVE EXAMPLE 1

A membrane-electrode assembly was prepared in the same method as described in Example 5 except for using a NAFION 115 polymer electrolyte membrane that had no corrugated surface structure. The membrane-electrode assembly was examined by measuring voltage current characteristics. Power density characteristics were obtained from the voltage-current measurement.

The results of Comparative Example 1 are drawn with open and filled reversed triangles in FIG. 12. Open marks (squares, triangles, or reversed triangles) refer to power density data shown in right y-axis of the graph, and filled marks refer to voltage data shown in left y-axis of the graph. As shown in FIG. 12, fuel cells of Examples 5 and 6, which have corrugated polymer electrolyte membranes, prove to have more excellent power output density than that of Comparative Example 1, which has a polymer electrolyte membrane that is not corrugated. This reason is that, in the corrugated polymer electrolyte membrane, the interface between the polymer electrolyte membrane and the catalyst layers increases, and thereby an amount of an activated catalyst increases.

Therefore, a membrane-electrode assembly for a fuel cell of the present invention including a corrugated polymer electrolyte membrane increases an area of an interface between a polymer electrolyte membrane and an electrode catalyst layer, providing a fuel cell system with high power and high performance.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A membrane-electrode assembly for a fuel cell comprising:
a polymer electrolyte membrane having a first surface on one side and a second surface on an opposite side, the first surface of the polymer electrolyte membrane having a corrugated pattern;
a first electrode substrate disposed on the first surface of the polymer electrolyte membrane, the side of the first electrode substrate disposed on the first surface having a corrugated pattern; and
a second electrode substrate disposed on the second surface of the polymer electrolyte membrane.

2. The membrane-electrode assembly of claim 1, comprised of the first surface of the polymer electrolyte membrane having a regular corrugated pattern.

3. The membrane-electrode assembly of claim 1, wherein an area ratio of the polymer electrolyte membrane is between about 1.3 and about 200.

4. The membrane-electrode assembly of claim 1, wherein a height of the corrugated pattern of the first surface of the polymer electrolyte membrane is between about 1 micro-meter and about 50 micro-meters.

5. The membrane-electrode assembly of claim 1, comprised of the corrugated pattern of the first electrode substrate being substantially the same as the corrugated pattern of the first surface of the polymer electrolyte membrane.

6. The membrane-electrode assembly of claim 1, comprised of the second surface of the polymer electrolyte membrane having a corrugated pattern.

7. The membrane-electrode assembly of claim 6, comprised of the side of the second electrode substrate disposed on the second surface having a corrugated pattern.

8. The membrane-electrode assembly of claim 6, comprised of the second surface of the polymer electrolyte membrane having a regular corrugated pattern.

9. The membrane-electrode assembly of claim 1, further comprising:
a first catalyst layer disposed between the first electrode substrate and the polymer electrolyte membrane; and
a second catalyst layer disposed between the second electrode substrate and the polymer electrolyte membrane.

10. A fuel cell system comprising:
an electricity generating element for producing electricity through electrochemical reaction of a fuel and an oxidant, the electricity generating element including:
a membrane-electrode assembly comprising:
a polymer electrolyte membrane having a first surface on one side and a second surface on an opposite side, the first surface of the polymer electrolyte membrane having a corrugated pattern;
a first electrode substrate disposed on the first surface of the polymer electrolyte membrane, the side of the first electrode substrate disposed on the first surface having a corrugated pattern;
a first catalyst layer disposed between the first electrode substrate and the polymer electrolyte membrane; and
a second electrode substrate disposed on the second surface of the polymer electrolyte membrane; and
separators disposed at both sides of the membrane-electrode assembly, and
a fuel supplier for supplying a fuel to the electricity generating element; and
an oxidant supplier for supplying an oxidant to the electricity generating element.

11. The fuel cell system of claim 10, wherein an area ratio of the polymer electrolyte membrane is between about 1.3 and about 200.

12. The fuel cell system of claim 10, wherein a height of the corrugated pattern of the first surface of the polymer electrolyte membrane is between about 1 micro-meter and about 50 micro-meters.

13. The fuel cell system of claim 10, comprised of the second surface of the polymer electrolyte membrane having a corrugated pattern, and the side of the second electrode disposed on the second surface having a corrugated pattern.

14. The fuel cell system of claim 10, comprised of the first surface of the polymer electrolyte membrane having a regular corrugated pattern.

15. The fuel cell system of claim 10, comprised of the corrugated pattern of the first electrode substrate being substantially the same as the corrugated pattern of the first surface of the polymer electrolyte membrane.

16. A method of making a membrane-electrode assembly comprising:
disposing a first electrode on a first patterned mold;
disposing a polymer electrolyte membrane on the first electrode; and
forming the pattern of the first patterned mold on a first surface of the polymer electrolyte membrane.

17. A method of making a membrane-electrode assembly of claim 16, further comprising:
disposing a second electrode on the polymer electrolyte membrane;
disposing a second patterned mold on the second electrode; and
forming the pattern of the second patterned mold on a second surface of the polymer electrolyte membrane.

18. A method of making a membrane-electrode assembly of claim 16, comprised of the step of forming the pattern of the first patterned mold on a first surface of the polymer electrolyte membrane including a step of pressing the polymer electrolyte membrane to the first patterned mold.

19. A method of making a membrane-electrode assembly of claim 18, wherein heat is applied during the step of pressing the polymer electrolyte membrane to the first patterned mold.

20. A method of making a membrane-electrode assembly of claim 16, further comprising a step of disposing a second electrode on the polymer electrolyte membrane after forming the pattern of the first patterned mold on a first surface of the polymer electrolyte membrane.
